(19) United States
(12) Patent Application Publication
(10) Pub. No.: US 2015/0153871 A1
(43) Pub. Date: Jun. 4, 2015

(54) TOUCH-SENSITIVE DEVICE AND METHOD

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: JIAN-HUNG HUNG, New Taipei (TW); GUANG-YAO LEE, New Taipei (TW); SHAN-JIA AO, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/185,731

(22) Filed: Feb. 20, 2014

(30) Foreign Application Priority Data
Nov. 30, 2013 (CN) 201310622059X

(51) Int. Cl. G06F 3/044

(52) U.S. Cl. CPC G06F 3/044

(57) ABSTRACT

A touch-sensitive method is applied in a touch-sensitive device including a touch-sensitive screen. The method includes the following steps. Detecting touch points on the touch-sensitive screen according to touch signals from the touch-sensitive screen. Determining a covered area of the touch points. Identifying a shape and a size of the covered area. Determining which part of a finger touches the touch-sensitive screen according to the identified shape and identified size of the covered area. Controlling the touch-sensitive device to perform different operations according to which part of the finger touches the touch-sensitive screen.

### FIELD

The present disclosure relates to electronic devices, and particularly to a touch-sensitive device, which can differentiate touch operations from different parts of a finger and a touch-sensitive method.

### BACKGROUND

Many electronic devices, such as mobile phones, tablet computers, and multimedia players, employ touch-sensitive screens as input interfaces. Such touch-sensitive screen can have a multi-touch function which can recognize the presence of two or more fingers contacting with the surface of the screen. This plural-finger awareness is often used to implement advanced functionality such as pinch to zoom. There are few functionalities that provide a new level of experience to a user operating the screen with a single finger.

### BRIEF DESCRIPTION OF THE DRAWINGS

Implementations of the present disclosure will now should be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views. The description is not to be considered as limiting the embodiments described herein.

FIG. 1 is a block diagram of a touch-sensitive device, in accordance with an exemplary embodiment.

FIG. 2 is a perspective view showing a fingertip touches the touch-sensitive device of FIG. 1 and a covered area of the fingertip, in accordance with an exemplary embodiment.

FIG. 3 is similar to FIG. 2, but showing a finger belly touches the touch-sensitive device of FIG. 1 and a covered area of the finger belly.

FIG. 4 is similar to FIG. 2, but showing a finger side touches the touch-sensitive device of FIG. 1 and a covered area of the finger side.

FIG. 5 is a flowchart of a touch-sensitive method, in accordance with an exemplary embodiment.

### DETAILED DESCRIPTION

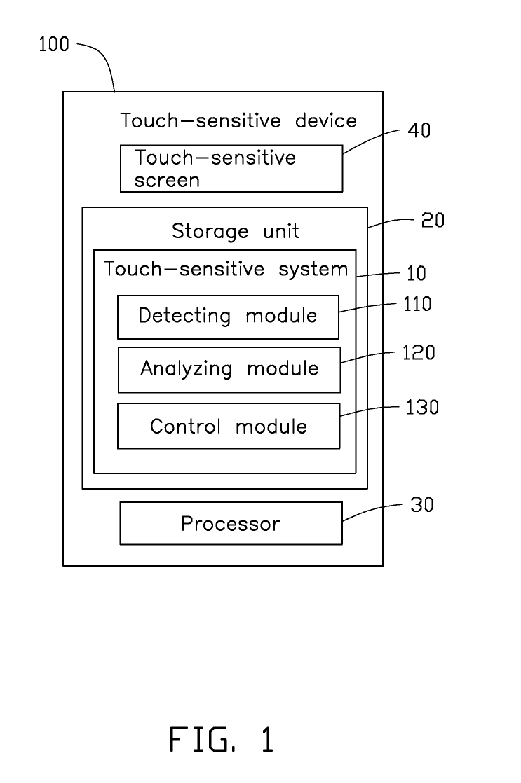

FIG. 1 is a block diagram of a touch-sensitive device 100 according to an exemplary embodiment. The device 100, such as a mobile phone, a tablet computer, or a multimedia player, includes a storage unit 20, a processor 30, and a touch-sensitive screen 40. The storage unit 20 stores a touch-sensitive system 10. The system 10 includes a variety of modules which are collection of software instructions executed by the processor 30 to provide the functions of the system 10. In this embodiment, the system 10 is executable by the processor 30 to detect which part of a finger touches the screen 40 and control the device 100 to perform a corresponding operation according to the detected result.

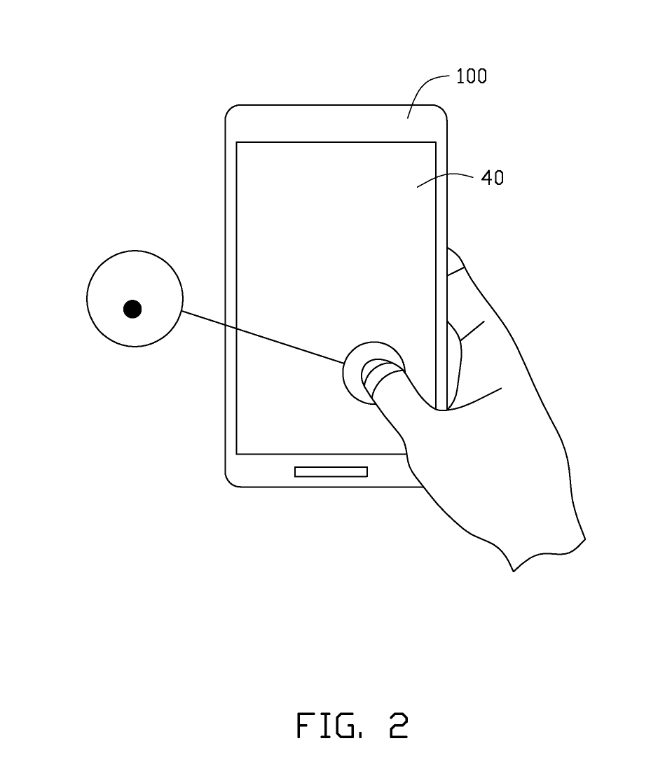

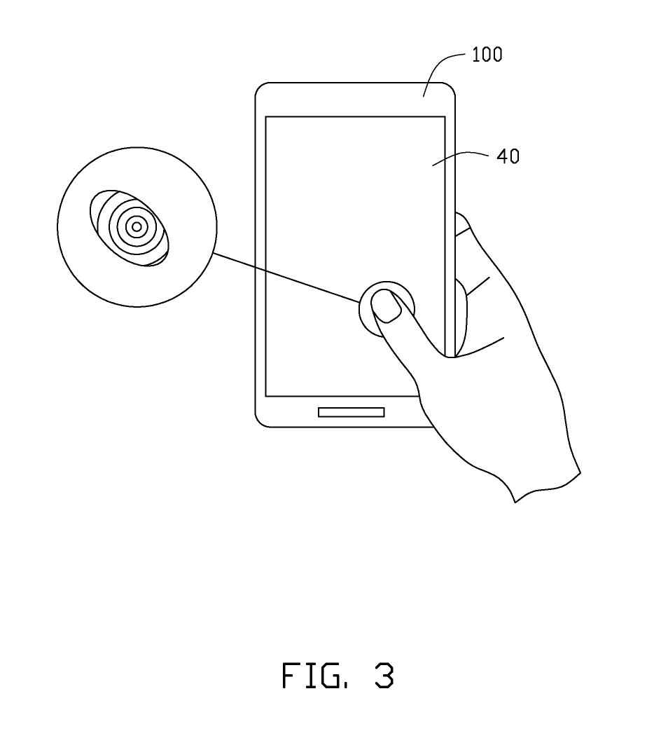

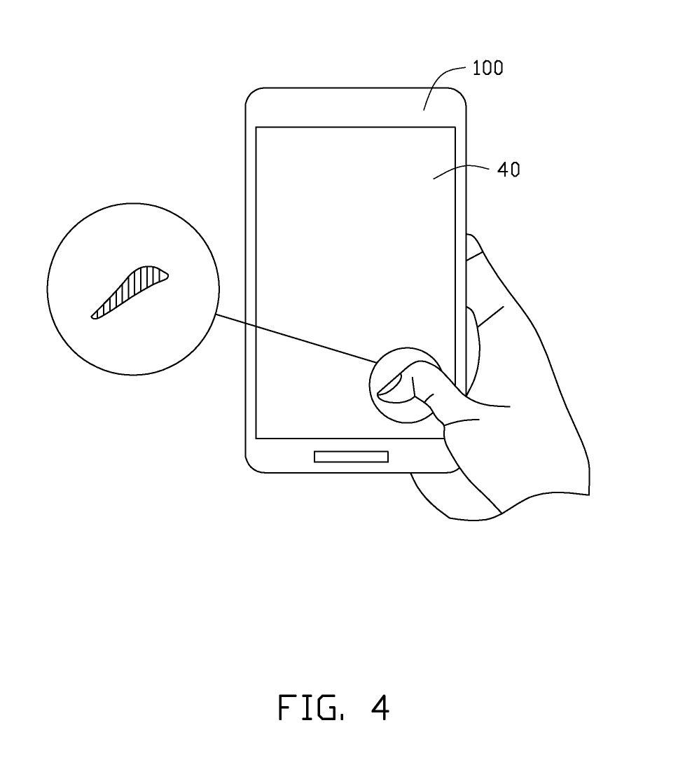

In detail, each time a touch operation is performed on the screen 40 by a finger, the finger covers an area on the screen 40, and a number of continuous positions within the covered area are simultaneously touched by the finger. The shape and the size of the covered area depend on which part of the finger touches the screen 40. FIGS. 2-4 show that when a fingertip or a finger belly touches the screen 40, the covered area is substantially circular. The covered area of the fingertip is less than the covered area of the finger belly. When a finger side touches the screen 40, the covered area is substantially triangular.

In the example illustrated in FIG. 1, the system 100 includes a detecting module 110, an analyzing module 120, and a control module 130.

The detecting module 110 detects touch points on the screen 40 according to touch signals from the screen 40, and determines the covered area of the touch points.

The analyzing module 120 identifies the shape and the size of the covered area and determines which part of a finger touches the screen 40 according to an identified shape and an identified size of the covered area. In the embodiment, if the identified shape of the covered area is substantially triangular, the analyzing module 120 determines that the finger side touches the screen 40. If the identified shape of the covered area is substantially circular, the analyzing module 120 further compares the identified size of the covered area with a preset size. If the identified size of the covered area is less than the preset size, the analyzing module 120 determines that the fingertip touches the screen 40. Otherwise, if the identified size of the covered area is greater than the preset size, the analyzing module 120 determines that the finger belly touches the screen 40.

The control module 130 controls the device 100 to perform different operations according to which part of the finger touches the screen 40 as determined by the analyzing module 120. In the embodiment, the device 100 displays a number of graphical icons on the screen 40. The analyzing module 120 further determines whether the covered area covers any graphical icon after determining which part of a finger touches the screen 40. The control module 130 controls the device 100 to perform different operations further according to whether the covered area covers any graphical icon as determined by the analyzing module 120.

Specifically, if the analyzing module 120 determines that the covered area covers one graphical icon, the control module 130 controls the device 100 to start the corresponding application when the fingertip touches the screen 40. At the same time, deletes the graphical icon from the screen 40 when the finger belly touches the screen 40, and further unloads the corresponding application when the finger side touches the screen 40. Otherwise, if the analyzing module 120 determines that the covered area does not cover any graphical icon, the control module 130 controls the screen 40 to switch to a next page when the fingertip touches the screen 40, zooms in the content corresponding to the covered area when the finger belly touches the screen 40, and further zooms out the content corresponding to the covered area when the finger side touches the screen 40.

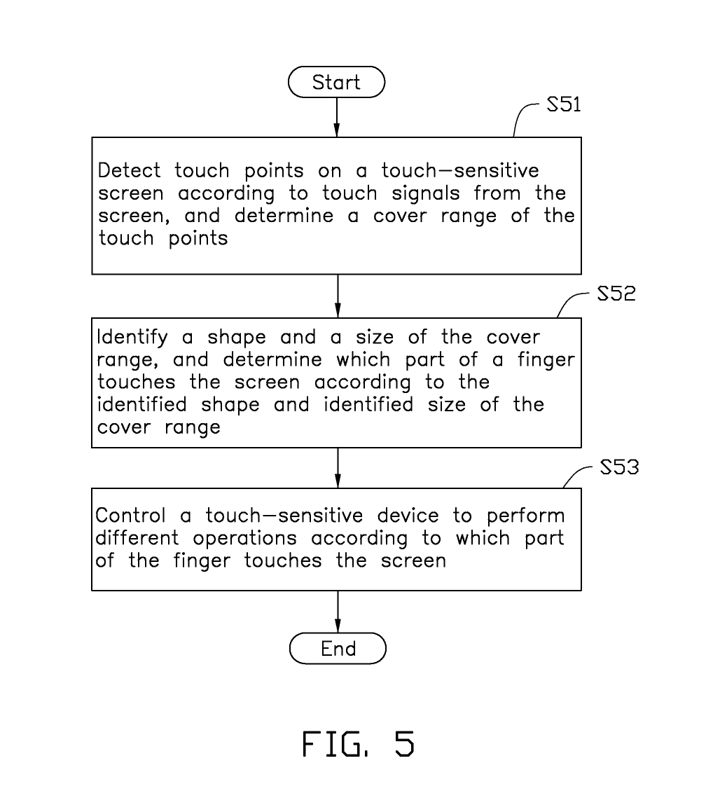

FIG. 5 is a flowchart of a touch-sensitive method, in accordance with an exemplary embodiment.

In block S51, the detecting module detects touch points on the screen according to touch signals from the screen, and determines the covered area of the touch points.

In block S52, the analyzing module identifies the shape and the size of the covered area, and determines which part of a finger touches the screen according to the identified shape and identified size of the covered area.

In block S53, the control module controls the device to perform different operations according to which part of the finger touches the screen as determined by the analyzing module.

It is believed that the present embodiments and their advantages will be understood from the foregoing description, and it will be apparent that various changes may be made thereto without departing from the scope of the disclosure or sacrificing all of its material advantages, the examples hereinbefore described merely being exemplary embodiments of the present disclosure.

What is claimed is:

1. A touch-sensitive device comprising:
a touch-sensitive screen;
a storage unit storing a plurality of modules; and
a processor to execute the plurality of modules,
wherein the plurality of modules comprises:
a detecting module to detect touch points on the touch-sensitive screen according to touch signals from the touch-sensitive screen, and determine a covered area of the touch points;
an analyzing module to identify a shape and a size of the covered area, and determine which part of a finger touches the touch-sensitive screen according to the identified shape and identified size of the covered area; and
a control module to control the touch-sensitive device to perform different operations according to which part of the finger touches the touch-sensitive screen as determined by the analyzing module.

2. The touch-sensitive device of claim 1, wherein if the identified shape of the covered area is substantially triangular, the analyzing module is configured to determine that a finger side touches the touch-sensitive screen, if the identified shape of the covered area is substantially circular, the analyzing module is further configured to compare the identified size of the covered area with a preset size, determine that a fingertip touches the touch-sensitive screen if the identified size of the covered area is less than the preset size, and determine that a finger belly touches the touch-sensitive screen if the identified size of the covered area is greater than the preset size.

3. The touch-sensitive device of claim 2, wherein the analyzing module is further configured to determine whether the covered area covers a graphical icon displayed on the touch-sensitive screen after determining which part of the finger touches the screen, and the control module is configured to control the touch-sensitive device to perform different operations further according to whether the covered area covers the graphical icon as determined by the analyzing module.

4. The touch-sensitive device of claim 3, wherein if the analyzing module determines that the covered area covers one graphical icon, the control module is configured to control the device to start a corresponding application when the fingertip touches the touch-sensitive screen, delete the graphical icon from the touch-sensitive screen when the finger belly touches the touch-sensitive screen, and further unloads the corresponding application when the finger side touches the touch-sensitive screen.

5. The touch-sensitive device of claim 3, wherein if the analyzing module determines that the covered area does not cover any graphical icon, the control module is configured to control the touch-sensitive screen to switch to a next page when the fingertip touches the touch-sensitive screen, zoom in a content corresponding to the covered area when the finger belly touches the touch-sensitive screen, and further zoom out a content corresponding to the covered area when the finger side touches the touch-sensitive screen.

6. A touch-sensitive method applied in a touch-sensitive device, the touch-sensitive comprising a touch-sensitive screen, the method comprising:
detecting touch points on the touch-sensitive screen according to touch signals from the touch-sensitive screen;
determining a covered area of the touch points;
identifying a shape and a size of the covered area;
determining which part of a finger touches the touch-sensitive screen according to the identified shape and identified size of the covered area; and
controlling the touch-sensitive device to perform different operations according to which part of the finger touches the touch-sensitive screen.

7. The touch-sensitive method of claim 6, wherein the step of determining which part of a finger touches the touch-sensitive screen according to the identified shape and identified size of the covered area further comprises:
determining that a finger side touches the touch-sensitive screen if the identified shape of the covered area is substantially triangular;
comparing the identified size of the covered area with a preset size if the identified shape of the covered area is substantially circular;
determining that a fingertip touches the touch-sensitive screen if the identified size of the covered area is less than the preset size; and
determining that a finger belly touches the touch-sensitive screen if the identified size of the covered area is greater than the preset size.

8. The touch-sensitive method of claim 6, wherein the step of controlling the touch-sensitive device to perform different operations according to which part of the finger touches the touch-sensitive screen further comprises:
determining whether the covered area covers a graphical icon displayed on the touch-sensitive screen;
controlling the touch-sensitive device to perform different operations according to which part of the finger touches the touch-sensitive screen and whether the covered area covers the graphical icon.
